(19) United States
(12) Patent Application Publication
(10) Pub. No.: US 2013/0007758 A1
(43) Pub. Date: Jan. 3, 2013

(54) MULTI-CORE PROCESSOR SYSTEM, THREAD SWITCHING CONTROL METHOD, AND COMPUTER PRODUCT

(75) Inventors: Koichiro Yamashita, Hachioji (JP); Hiromasa Yamauchi, Kawasaki (JP); Kiyoshi Miyazaki, Machida (JP)

(73) Assignee: FUJITSU LIMITED, Kawasaki-shi (JP)

(21) Appl. No.: 13/614,071

(22) Filed: Sep. 13, 2012

Related U.S. Application Data
(63) Continuation of application No. PCT/JP2010/054708, filed on Mar. 18, 2010.

(51) Int. Cl. G06F 9/46

(52) U.S. Cl. 718/103; 718/102

(57) ABSTRACT

A multi-core processor system includes a given core configured to switch at a prescribed switching period, threads assigned to the given core; identify whether the given core has switched threads at a period exceeding the prescribed switching period; correct the prescribed switching period into a shorter switching period, based on a difference of an actual switching period at which the threads have been switched by the given core and the prescribed switching period; and set the corrected switching period as the prescribed switching period.

### CROSS REFERENCE TO RELATED APPLICATIONS

This application is a continuation application of International Application PCT/JP2010/054708, filed on Mar. 18, 2010 and designating the U.S., the entire contents of which are incorporated herein by reference.

### FIELD

The embodiment discussed herein is related to a multi-core processor system and a thread switching control method.

### BACKGROUND

A multi-programming technique of causing one central processing unit (CPU) to run multiple programs has been known as conventionally. For example, an operating system (OS) has a function of dividing the processing time of the CPU and assigning processes and threads to the resulting timeslots so that the CPU runs multiple processes and threads concurrently. A process and a thread are units of executing programs. Software is composed of a set of processes and threads. Generally, memory space is independent among processes but is shared by threads.

A technique of changing thread switching periods has been disclosed. According to the technique when there are numerous threads, the frequency of processing of each thread is increased by shortening the switching period so that CPU resources are distributed to each thread (see, e.g., Japanese Laid-Open Patent Publication No. H3-019036).

A technology of a multi-core processor system having a computer system equipped with multiple CPUs has also been disclosed. An application of the above multi-programming technique to the disclosed system enables the OS to assign multiple programs to multiple CPUs. Multi-core processor systems of different configurations are disclosed. One is a multi-core processor system having a distributed system structure such that each CPU has dedicated memory and accesses shared memory when other data is needed. Another is a multi-core processor system having a centralized shared system structure such that each CPU has only cache memory and stores necessary data in shared memory.

A thread switching technique for a multi-core processor system has been disclosed. According to the disclosed technique, after a collision between a given process executed in time slices and a high-priority process, a delay time is added to time slices at the resumption of processes and then the given process is resumed (see, e.g., Japanese Laid-Open Patent Publication No. H8-314740).

Nonetheless, the multi-core processor system having the centralized share system poses a problem in that when a contention state arises due to access contention, the time for completing a real-time process exceeds a set time. A real-time process refers to a process that must end at a predetermined time consequent to design specifications and further refers to a process where an allowable interval time between the occurrence of an interrupt event and the start of an interrupt process is fixed in an interrupt operation.

The techniques disclosed in Japanese Laid-Open Patent Publication Nos. H3-019036 and H8-314740 do not address access contention, arising in a problem that the response performance of the real-time process fails during contention.

### SUMMARY

According to an aspect of an embodiment, a multi-core processor system includes a given core configured to switch at a prescribed switching period, threads assigned to the given core; identify whether the given core has switched threads at a period exceeding the prescribed switching period; correct the prescribed switching period into a shorter switching period, based on a difference of an actual switching period at which the threads have been switched by the given core and the prescribed switching period; and set the corrected switching period as the prescribed switching period.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a block diagram of a hardware configuration of a multi-core processor system 100 according to an embodiment;

FIG. 2 is a block diagram of a hardware configuration and a software configuration of each CPU in the multi-core processor system 100;

FIG. 3 is a block diagram of a functional configuration of the multi-core processor system 100;

FIG. 4 is an explanatory diagram of a dispatched state of software in a case of executing software by a single CPU;

FIG. 5 is an explanatory diagram of a delay in a real-time response that happens in a contention state in a conventional example of the multi-core processor system 100;

FIG. 6 is an explanatory diagram of a state that results after correction of a time slice by the multi-core processor system 100 according to the embodiment;

FIG. 7 is an explanatory diagram of an example of the contents of the software table 310;

FIG. 8 is an explanatory diagram of an example of real-time processes;

FIG. 9 is a flowchart of a time slice setting process including thread switching in the multi-core processor system 100; and

FIG. 10 is a flowchart of a time slice correcting process by a hypervisor.

### DESCRIPTION OF EMBODIMENTS

Preferred embodiments of a multi-core processor system, a thread switching control method, and a thread switching control program according to the present invention will be explained with reference to the accompanying drawings.

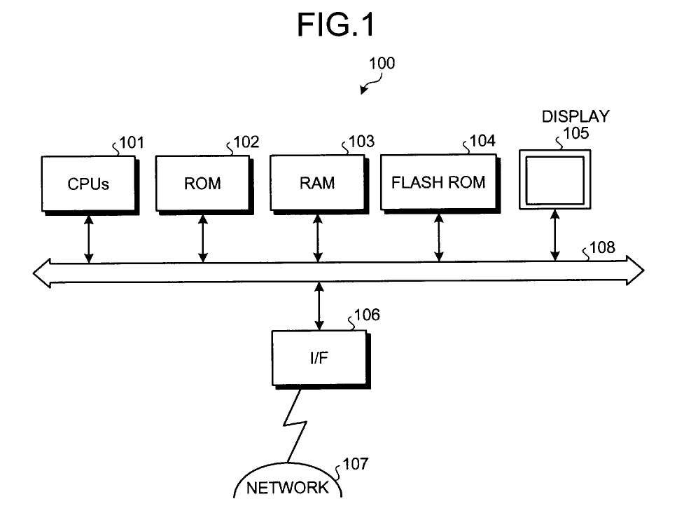

FIG. 1 is a block diagram of a hardware configuration of a multi-core processor system 100 according to an embodiment. A multi-core processor system is a computer system that includes a processor equipped with multiple cores. Provided the cores are provided in plural, the system may include a single processor equipped with multiple cores or a group of single-core processors in parallel. In the embodiment, for the sake of simplicity, an example will be described using a group of CPUs that are single-core processors in parallel.

A multi-core processor system 100 includes multiple CPUs 101, read-only memory (ROM) 102, random access memory (RAM) 103, and flash ROM 104. The multi-core processor system includes a display 105 and an interface (I/F) 106 as input/output devices for the user and other devices. The components of the multi-core system 100 are respectively connected by a bus 108.

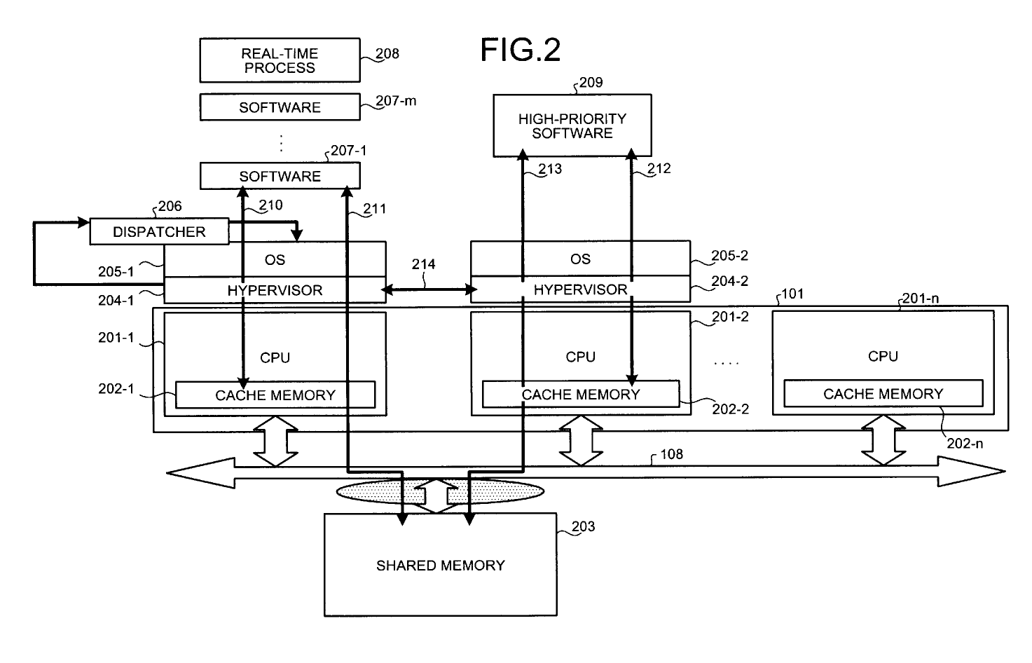

The CPUs 101 govern overall control of the multi-core processor system 100. The CPUs 101 refer to CPUs that are single core processors connected in parallel. Details of the CPUs 101 will be described hereinafter with reference to FIG. 2. The ROM 102 stores therein programs such as a boot program. The RAM 103 is used as a work area of the CPUs 101.

The flash ROM 104 is re-writable, non-volatile semiconductor memory that maintains data even if power is cut to the memory. The flash ROM 104 stores software programs and data. Although software programs and data may be stored to a hard disk drive (HDD), which is a magnetic disk, in place of the flash ROM, use of the flash ROM 104 enables greater resistance to vibration compare to the mechanically operating HDD. For example, even if apparatuses configuring the multi-core system are subject to strong external forces, by using the flash ROM 104, the potential of data can be lowered.

The display 105 displays, for example, data such as text, images, functional information, etc., in addition to a cursor, icons, and/or tool boxes. A thin-film-transistor (TFT) liquid crystal display and the like may be employed as the display 105.

The I/F 106 is connected to the network 107 such as a local area network (LAN), a wide area network (WAN), and the Internet through a communication line and is connected to other apparatuses through the network 107. The I/F 106 administers an internal interface with the network 107 and controls the input/output of data from/to external apparatuses. For example, a modem or a LAN adaptor may be employed as the I/F 106.

FIG. 2 is a block diagram of a hardware configuration and a software configuration of each CPU in the multi-core processor system 100. The hardware configuration of the multi-core processor system 100 includes CPUs 101 and shared memory 203. The CPUs 101 represent multiple CPUs including a CPU 201-1, a CPU 201-2, . . . , a CPU 201-n.

The CPU 201-1, the CPU 201-2, . . . , the CPU 201-n have cache memory 202-1, cache memory 202-2, . . . , a cache memory 202-n, respectively. Each CPU and the shared memory 203 are interconnected via a bus 108. Description will be given using the CPU 201-1 and CPU 201-2.

In the software configuration of the multi-core processor system 100, the CPU 201-1 executes a hypervisor 204-1 and an OS 205-1. The CPU 201-1 executes a dispatcher 206 under the control of the OS 205-1. The CPU 201-1 also executes software 207-1 to software 207-m under the control of the OS 205-1. In the same manner, the CPU 201-2 executes a hypervisor 204-2 and an OS 205-2. The CPU 201-1 executes the dispatcher 206 under the control of the OS 205-1. The hypervisor 204-1 carries out a time slice correcting process, which is a feature of the embodiment, using a result of execution of the dispatcher 206. The CPU 201-2 executes high-priority software 209 under the control of the OS 205-2.

When the CPU 201-1 executes the software 207-1 to software 207-m, the CPU 201-1 accesses data through two paths, an access path 210 and an access path 211. Similarly, when the CPU 201-2 executes the high-priority software 209, the CPU 201-2 accesses data through two paths, an access path 212 and an access path 213. The hypervisor 204-1, the hypervisor 204-2, and hypervisors running on other CPUs carry out inter-hypervisor communication 214.

The CPU 201-1, the CPU 201-2, . . . , the CPU 201-n are in charge of control over the multi-core processor system 100. The CPU 201-1, the CPU 201-2, . . . , the CPU 201-n may work as symmetric multi-processing (SMP) units to which processes are assigned symmetrically and uniformly, or may work as asymmetric multi-processing (ASMP) units each of which is assigned tasks depending on the contents of a process. As an example of ASMP, according to the multi-core processor system 100 of the embodiment, a real-time process 208 is assigned to the CPU 201-1, the CPU 201-2, . . . , the CPU 201-n, and the real-time process 208 must be carried out within a period determined by the CPU 201-1.

The shared memory 203 is a memory area accessible by the CPU 201-1, the CPU 201-2, . . . , the CPU 201-n. Memory areas are for example, the ROM 102, the RAM 103, and the flash ROM 104. For example, when the CPU 201-1 requests the display 105 to display image data, the CPU 201-1 accesses Video RAM (VRAM) included in the RAM 103 and writes image data to the VRAM. A case of the CPU 201-1 accessing the display 105 is, therefore, regarded as a case of accessing the shared memory 203.

For example, the CPU 201-1 accessing the I/F 106 is also regarded as the same case. For example, when the I/F 106 is a LAN adaptor, the CPU' access pattern is either accessing a buffer included in the LAN adaptor or accessing the RAM 103 and then transferring data to the LAN adaptor. Both cases are regarded as a case of accessing the shared memory 203 from the viewpoint of access by the CPU 201-1 and CPU 201-2. The case of the CPU 201-1 and CPU 201-2 accessing the I/F 106 is, therefore, also regarded as a case of accessing the shared memory 203. When the CPU 201-1 accesses the I/F 106, the CPU 201-1 accesses a shared memory area prepared by a device driver controlling the I/F 106. Hence, the CPU 201-1 actually accesses the shared memory 203.

The hypervisor 204-1 and the hypervisor 204-2 are programs that run on the CPU 201-1 and the CPU 201-2, respectively. A function of the hypervisor positioned between the OS and the CPU is to monitor the OS and reset the OS when it hangs or set a power-saving mode when the OS is not executing any threads. The hypervisor controls the cache of the processor (this cache cannot be manipulated by an ordinary program) and operates a special register that carries out I/O operations. The hypervisor runs using a memory space to/from which an ordinary program cannot write/read.

The OS 205-1 and the OS 205-2 are programs that run on the CPU 201-1 and the CPU 201-2, respectively, where the OS 205-1 and the OS 205-2 run on the hypervisor 204-1 and the hypervisor 204-2, respectively. For example, the OS 205-1 has a function of a scheduler that determines software to be executed next.

The dispatcher 206 has a function of switching from software currently under execution to the next software determined by the scheduler. For example, when switchover is made from the software 207-1 to the software 207-2 determined by the scheduler, the CPU 201-1 saves register information including information of a program counter, etc., concerning the software 207-1. After saving the register information, the CPU 201-1 retrieves register information concerning the software 207-2 that has been saved. After retrieving the register information, the CPU 201-1 can resume processing by the software 207-2 from the point at which the previous software switch occurred.

The software 207-1, . . . , software 207-m each realize a given function as a result of execution of execution code by the CPU. Software is made up of one or more threads. The software 207-1, . . . , software 207-m execute processes regardless of an end time.

The real-time process 208 is an interrupt handler that is a process carried out when an interrupt signal is received. Interrupts include a hardware interrupt and a software interrupt. For example, for a hardware interrupt, a communication device reports data reception as an interrupt signal, to a CPU. Receiving the report, the CPU executes the interrupt handler corresponding to the data reception by the communication device. Details of the process by the interrupt handler include the transfer of received data from the memory area of the communication device to the RAM 103 and flash ROM 104. The CPU receiving the interrupt signal saves a process of the current thread and executes the interrupt handler if not in an interrupt disabled section.

The high-priority software 209 is software given a high-priority attribute relative to other software. The high-priority software is characterized in that its dispatch frequency is higher than that of other software, and in that when resource contention arises over access to the memory, the high-priority software is able to acquire an access right with preference over other software.

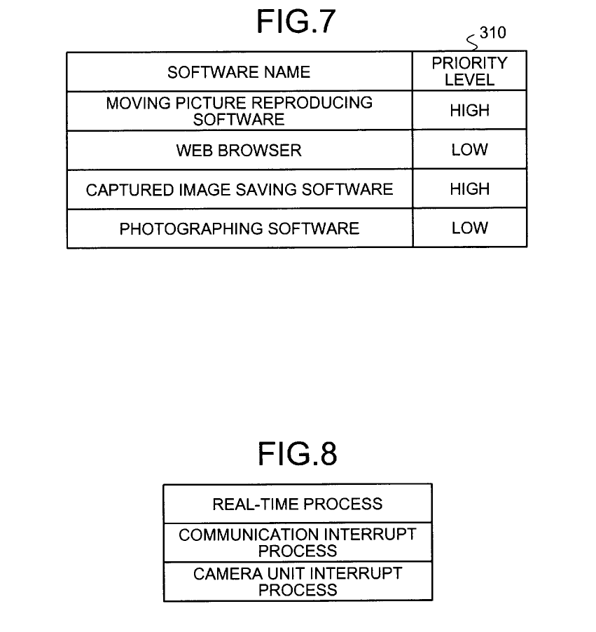

According to this embodiment, the software 207-1, . . . , software 207-m and the real-time process 208 are executed at the CPU 201-1, and the high-priority software 209 is executed at the CPU 201-2. Examples of the software 207-1, . . . , software 207-m and the high-priority software 209 will be described later with reference to FIG. 7. A specific example of the real-time process 208 will be described later with reference to FIG. 8.

The access path 210 is the path through which the CPU 201-1 accesses the cache memory 202-1. The access path 211 is the path through which the CPU 201-1 accesses the shared memory 203. The access path 210 and the access path 211 are used in different cases in such a way that, for example, if the software 207-1 finds data to access to be in the cache memory 202-1, the software 207-1 uses the access path 210, and when finding the data to be not in the cache memory 202-1, the software 207-1 uses the access path 211. The access path 212 and the access path 213 are used in the same manner as the access path 210 and the access path 211. The access path 212 is the path through which the CPU 201-2 accesses the cache memory 202-2. The access path 213 is the path through which the CPU 201-2 accesses the shared memory 203.

A contention state due to access contention arises when multiple CPUs access the shared memory 203. For example, when the access path of the CPU 201-1 is the access path 211 and the access path of the CPU 201-2 is the access path 213, contention consequent to accesses of the shared memory 203.

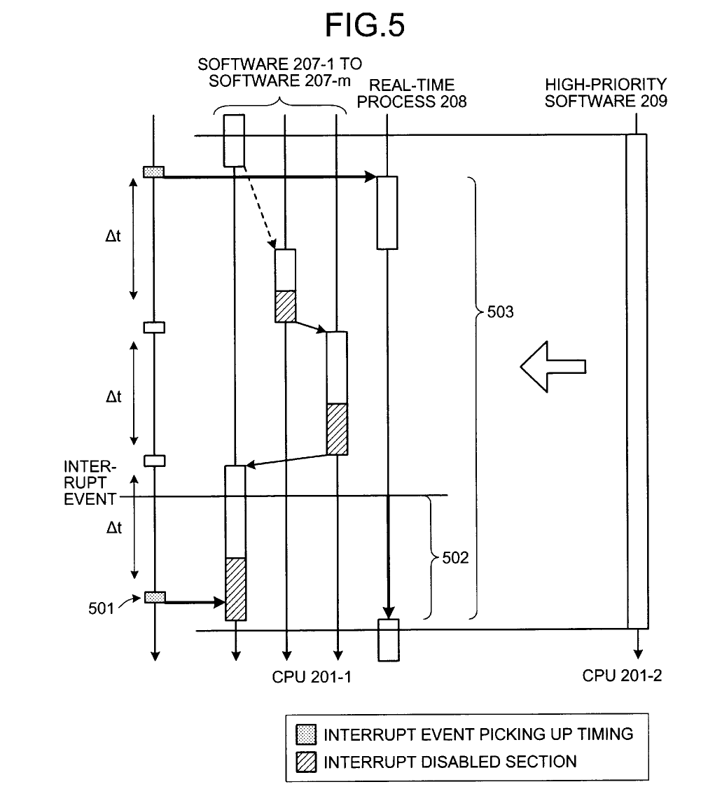

When contention arises, a process by software is delayed, so that an interrupt disabled interval in the process by the software becomes longer than the initial interrupt disabled interval. As a result, when an interrupt signal is reported to the CPU in the interrupt disabled interval, the real-time process 208, which is the interrupt handler, cannot be executed. This is a condition where the response performance of the real-time process 208 cannot be guaranteed. A contention state where the response time of the real-time process 208 cannot be guaranteed will be depicted in FIG. 5 later.

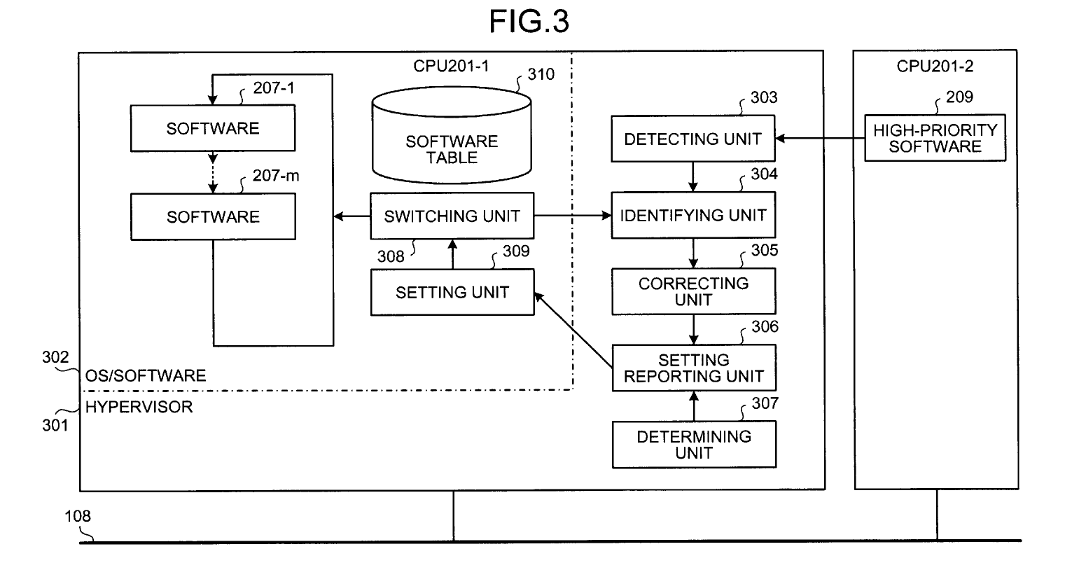

A functional configuration of the multi-core processor system 100 will be described. FIG. 3 is a block diagram of a functional configuration of the multi-core processor system 100. The multi-core processor system 100 includes a detecting unit 303, an identifying unit 304, a correcting unit 305, a setting reporting unit 306, a determining unit 307, a switching unit 308, and a setting unit 309. Functions of these units (detecting unit 303 to setting unit 309) serving as a control unit are realized by, for example, causing the CPUs 101 to execute programs stored in the memory devices of FIG. 1, such as ROM 102, RAM 103, and flash ROM 104. The functions may also be realized by causing a different CPU to execute programs via the I/F 106.

To determine a priority level of software, the multi-core processor system 100 accesses a software table 310. The software table 310 is stored in the shared memory 203, and is accessed by, for example, the CPU 201-1.

The CPU 201-1, the CPU 201-2, . . . , the CPU 201-n execute the hypervisor and the OS/software. The detection unit 303 to the determining unit 307 depicted in an area 301 among areas divided by a single-point broken line are executed by the CPU 201-1, as part of the function of the hypervisor 204-1. Similarly, the switching unit 308 and the setting unit 309 depicted in an area 302 are executed by the CPU 201-1, as part of the function of the OS 205-1. Although not depicted, each core other than the CPU 201-1 has the functions of the detecting unit 303 to the setting unit 309.

The detecting unit 303 has a function of detecting from among multiple cores, a core to which an arbitrary thread is assigned. Multiple cores means the CPU 201-1, the CPU 201-2, . . . , the CPU 201-n. For example, the detecting unit 303 detects assignment of the high-priority software 209 to the CPU 201-2, via the inter-hypervisor communication 214. Information concerning a detected core is stored in a memory area, such as the cache memory 202-1 and a general-purpose register of the CPU 201-1.

The identifying unit 304 has a function of identifying whether the CPU 201-1 has switched threads at a period exceeding a prescribed switching period via the switching unit 308. A prescribed switching period means a time slice that is equivalent to a switching period At required for switching a thread. Multiple threads means software 207-1 to software 207-m executed on the CPU 201-1.

Triggered by detection of a core by the detecting unit 303, the identifying unit 304 may perform identification. The identifying unit 304 may be triggered by the detection of a core by the detecting unit 303, to identify a core when the priority level of the thread assigned to the core detected by the detecting unit 303 is higher than the priority level of the thread to which the switching unit 308 has switched via the thread switching.

For example, assuming a case where the switching unit 308 switches the software to be assigned to the CPU 201-1, to software 207-1 to software 207-m. In this case, when a period AC allocated to the software 207-1 exceeds the period At, the identifying unit 304 identifies that CPU 201-1 has switched multiple threads during a period exceeding the prescribed switching period.

The period AC allocated to the software 207-1 can be acquired from a difference of a clock counter at a point of time of assignment of the software 207-1 and the clock counter at a point of time of assignment of the software 207-2. Information concerning an identified core is stored to a memory area, such as the cache memory 202-1 and the general-purpose register of the CPU 201-1.

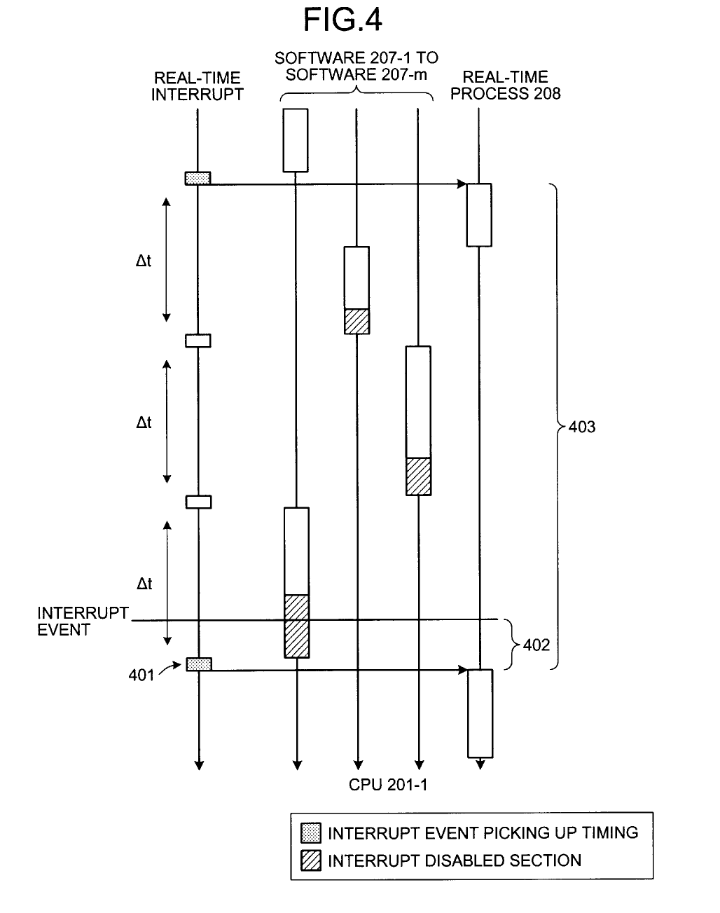

The correcting unit 305 has a function of correcting the prescribed switching period into a shorter switching period, based on a difference of the actual switching period taken to switch multiple threads at the core identified by the identifying unit 304 and the prescribed switching period. When the difference exceeds a prescribed interrupt disabled period, the correcting unit 305 may correct the prescribed switching period into a shorter switching period based on the difference. The prescribed interrupt disabled period is the longest path period lck (Locked Critical Kidnapping-period) of the interrupt disabled interval set by the implementation rules. The detail of lck will be described later, referring to FIG. 4.

As an example of an equation for calculating a shorter switching period resulting from correction based on the difference, equation (1) may be used.

Corrected switching period=given switching period−(actual switching period−given switching period) (1)

Equation (1) indicates that the time delay caused by contention is set equivalent to the amount of time to be cut from a thread switching period. An interval of detection of interrupt events is reduced by an amount equivalent to the delay time, there by increasing the frequency of detection of interrupt events. As a result, the response performance of the real-time process can be guaranteed. When the difference exceeds the prescribed interrupt disabled period, equation (2) may be adopted.

Corrected switching period=given switching period−((actual switching period−given switching period)−(given interrupt disabled period)) (2)

In equation (2), the amount of time cut by switching period correction is made smaller than that of equation (1) for the reason that unless the delay time exceeds the prescribed interrupt disabled period, the response performance of the real-time process is guaranteed according to the implementation rules. Excessively reducing the thread switching period invites performance deterioration due to thread dispatching overhead. If a satisfactory performance response of the real-time process is possible, calculation is not limited to equations (1) and (2), any equation that defines a corrected switching period shorter than the original may be adopted.

For example, when the actual switching period is 13 [microseconds] and the prescribed switching period is 10 [microseconds], the difference of the switching periods is 3 [microseconds]. From equation (1), therefore, the corrected switching period is calculated to be 7 [microseconds]. The corrected switching period is stored to a memory area, such as the cache memory 202-1 and the general-purpose register of the CPU 201-1.

The setting reporting unit 306 has a function of reporting a corrected switching period given by the correcting unit 305, to the OS. When the determining unit 307 determines that access contention is not occurring, the setting reporting unit 306 may notify the OS to set the corrected switching period to the pre-correction original switching period. As report contents, the setting reporting unit 306 may report a difference calculated by (actual switching period-prescribed switching period). When the determining unit 307 determines that access contention is not occurring, the setting reporting unit 306 may report the pre-correction original switching period, i.e., the switching period before correction.

For example, the setting reporting unit 306 reports the corrected switching period 7 [microseconds] given by the correcting unit 305, to the OS. The reported switching period is stored to a memory area, such as the cache memory 202-1 and the general-purpose register of the CPU 201-1.

The determining unit 307 has a function of determining whether a memory accessed by a core identified by the identifying unit 304 is in a state of access contention. For example, the CPU 201-1 calculates (clock counter value/number of issued commands) based on the number of commands issued by the CPU and a record of the clock counter in a given period. When a calculated value is larger than a given value, the CPU 201-1 determines that a state of access contention is occurring.

For example, when (clock counter value/number of issued commands)>1000 results, the calculation result indicates that 1000 clocks are consumed for one command, which case is determined to be a state of access contention. A determined result is stored to a memory area, such as the cache memory 202-1 and the general-purpose register of the CPU 201-1.

The switching unit 308 has a function of switching at a prescribed switching period, threads respectively assigned to cores. For example, the switching unit 308 switches the software 207-1 to software 207-m in the prescribed switching period Δt. When the setting unit 309 reduces the switching period from Δt to Δt′, the switching unit 308 switches the software 207-1 to software 207-m in the switching period Δt′. Information of switched software may be stored to a memory area, such as the shared memory 203.

The setting unit 309 has a function of setting a corrected switching period reported by the setting reporting unit 306, as a thread switching period. When the setting reporting unit 306 reports a pre-correction switching period to the setting unit 309, the setting unit 309 may set the pre-correction prescribed switching period as the thread switching period.

For example, when the setting reporting unit 306 reports the corrected switching period Δt′ to the setting unit 309, the setting unit 309 sets the corrected switching period Δt′ as the thread switching period. The set thread switching period may be stored in the memory area, such as shared memory 203.

FIG. 4 is an explanatory diagram of a dispatched state of software in a case of executing the software by a single CPU. In FIG. 4, the CUP 201-1 is running in the multi-core processor system 100, and executes the software 207-1 to software 207-m. The CPU 201-1 executes the software 207-1 to software 207-m sequentially in the thread switching period Δt, and when receiving a real-time interrupt signal, executes the real-time process 208 as the interrupt handler.

To allow the multi-core processor system 100 to guarantee the response performance of the real-time process, the real-time process must be carried out according to the following two conditions. A first condition is that following the occurrence of an interrupt event, the CUP 201-1 must execute the real-time process corresponding to the interrupt event within a real-time interrupt period. A second condition is that the CUP 201-1 must carry out the real-time process at least once within a real-time response time. An interrupt event is an event of reception of an interrupt signal. Even if an interrupt event occurs, the CPU is not able to immediately execute the real-time process when in the interrupt disabled interval. The CPU becomes able to carry out the real-time process after the end of the interrupt disabled interval.

For example, in the state depicted in FIG. 4, a period 402 from the time at which an interrupt event occurs and including an interrupt event picking up timing 401 until the real-time process 208 is carried out, is within the real-time interrupt period. In addition, a period 403 for carrying out the real-time process 208 must be the real-time response time. Generally, the real-time interrupt period is on the order of microseconds, and the real-time response time is on the order of several milliseconds. For example, the real-time interrupt period may be 10 [microseconds] and the real-time response time may be 10 [milliseconds].

Interrupt disabled intervals are embedded in processes carried out by the software 207-1 to software 207-m. The reason for embedding interrupt disabled intervals is that, for example, intentional cache manipulation, saving/retrieving register data, etc., must be carried out as continuous processes that are not interrupted by other processes. The CPU in an interrupt disabled interval is not able to execute pre-emption, such as context switch. An interrupt disabled interval is set in such a way that at the stage of system design, the longest path period lck of the interrupt disabled interval is set in the form of the implementation rules and an implementer implements software so that the interrupt disabled interval does not exceed the longest path period lck.

The implementer sets the longest path period lck so that as long as the interrupt disabled interval does not exceed the longest path period lck, the real-time process within the real-time interrupt period and the real-time response time is guaranteed even if an interrupt occurs during the interrupt disabled interval. When software is executed on a single CPU, therefore, the response performance of the real-time process is guaranteed even if an interrupt event occurs during the interrupt disabled interval.

FIG. 5 is an explanatory diagram of a delay in a real-time response that happens in a contention state in a conventional example of the multi-core processor system 100. In FIG. 5, the CUP 201-1 and the CPU 201-2 are running in the multi-core processor system 100, and the CUP 201-1 executes the software 207-1 to software 207-m. The CPU 201-1 executes the software 207-1 to software 207-m sequentially in the thread switching period Δt, and when receiving a real-time interrupt signal, executes the real-time process 208 as the interrupt handler. The CPU 201-2 executes the high-priority software 209.

Because the CPU 201-2 is executing the high-priority software 209, the multi-core processor system 100 allocates various resources preferentially to the high-priority software 209. For example, it is assumed that the CUP 201-1 and the CPU 201-2 access the shared memory 203 at the same time. In this case, the multi-core processor system 100 carries out control to allow the CPU 201-2 executing the high-priority software 209 to access the shared memory 203 preferentially over the CUP 201-1.

The CPU 201-1, therefore, has to standby until the CPU 201-2 completes accessing the shared memory 203. Hence, a contention state results due to access contention. The CPU 201-1 in the contention state delays in its processing. This delay in processing then delays in the completion of an interrupt disabled interval. As a result, when the interrupt disabled interval exceeds the longest path period lck, guaranteeing the response performance of the real-time process becomes impossible.

In the example depicted in FIG. 5, when an interrupt event has occurred and an interrupt event picking up timing 501 has arrived, the CPU 201-1 is in an interrupt disabled interval. The CPU 201-1, therefore, is not able to immediately execute the real-time process 208, and is forced to execute the real-time process 208 after the end of the interrupt disabled interval.

Consequently, when a period 502 from the occurrence of the interrupt event and execution of the real-time process 208 exceeds a real-time interrupt period, the multi-core processor system 100 becomes unable to guarantee the response performance of the real-time process. Likewise, when a period 503 for carrying out the real-time process 208 exceeds a real-time response time, the multi-core processor system 100 becomes unable to guarantee the response performance of the real-time process.

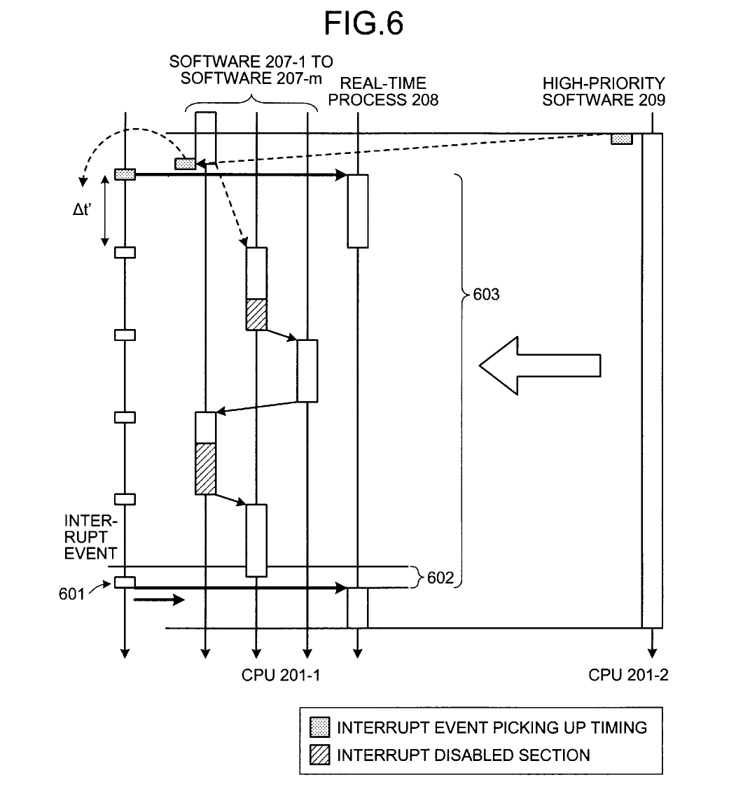

FIG. 6 is an explanatory diagram of a state that results after correction of a time slice by the multi-core processor system 100 according to the embodiment. In FIG. 6, the execution state of hardware and software is the same as that in FIG. 5 but the thread switching period is reduced from Δt to Δt′ via correction.

The reduction of the thread switching period facilitates guarantee the response performance of the real-time process by the multi-core processor system 100. To ensure the response performance, the real-time process must be carried out within the real-time interrupt period and within the real-time response time, as described in FIG. 4.

Carrying out the real-time process within the real-time interrupt period becomes possible because the reduction of the thread switching period shortens the interval of detection of interrupt events, thus increasing the frequency of detection of interrupt events. Hence, a period 602 from the time at which an interrupt event occurs and including the interrupt event picking up timing 601, until the real-time process 208 is executed, is reduced, enabling the real-time interrupt period to he shortened.

Carrying out the real-time process within the real-time response time becomes possible because the reduction of the thread switching period increases the number of times that processing is executed by treads executed in the CPU. For example, it is assumed that a CPU executes 200 threads and allows each thread to take 10 [microseconds] for one round of processing. It is also assumed that an interrupt event that triggers execution of the real-time process occurs as a result of execution of a given thread among the 200 threads.

In this case, if priority levels of all threads are equal, each thread is able to carry out its process once every 2 [milliseconds]. When the time each thread takes for one round of processing becomes longer because of a contention state, a reduction of the thread switching period results in an increase in the number of times that processing is executed by the given thread. As a result, the period 603 for carrying out the real-time process 208 can be reduced to be shorter than the real-time response time.

FIG. 7 is an explanatory diagram of an example of the contents of the software table 310. The software table 310 is a list of software executed by the multi-core processor system 100, and has two fields including a software name field and a priority level field.

The software name field includes the names of software. In practice, a program describing process contents is present in any one of the ROM 102, the RAM 103, and the flash ROM 104. For example, the CPU 201-1 downloads a program and executes it as a thread. The priority level field includes set priority levels of the software. The priority levels are taken into account at execution of the software. When detecting software having a high priority level, the multi-core processor system 100 delivers an access right to the bus 108, etc., preferentially to the software having the high priority level.

For example, “moving picture reproducing software” is started by a user, and is given a high priority level when running in a foreground environment, whereas “Web browser” is given a low priority level. Another case is assumed where the multi-core processor system 100 having a camera unit takes continuous photos. For continuous photographing, “captured image saving software” for saving images captured by the camera is given a high priority level while “photographing software” is given a low priority level.

FIG. 8 is an explanatory diagram of an example of real-time processes. A “communication interrupt process” is a real-time process that is executed on an interrupt event from communication hardware, such as the I/F 106. Communication is caused by, for example, software, such as “Web browser”. When receiving data, the I/F 106 has to send within a given period, a response notice confirming data reception to the device that transmitted the data, according to the protocol for the data. If the response notice is not sent within the given period, the device that transmitted the data concludes that the process is timed out. The multi-core processor system 100, therefore, has to carry out the response notice sending process within the given period.

A “camera unit interrupt process” is a real-time process executed by the camera unit. In the camera unit interrupt process, image data is taken using the “photographing software”, and is stored to a buffer. If the CPU 201-1 does not transfer the stored image data from the buffer to, for example, the shared memory 203, data overflow occurs. As a result, some image data is lost.

The above “communication interrupt process” and “camera unit interrupt process” are carried out without problem in a system with a single core that operates while switching tasks. According to a conventional example of the multi-core processor system 100, however, when one CPU executes a real-time process as a different CPU executes high-priority software, access contention occurs and consequently, the response performance of the real-time process cannot be guaranteed.

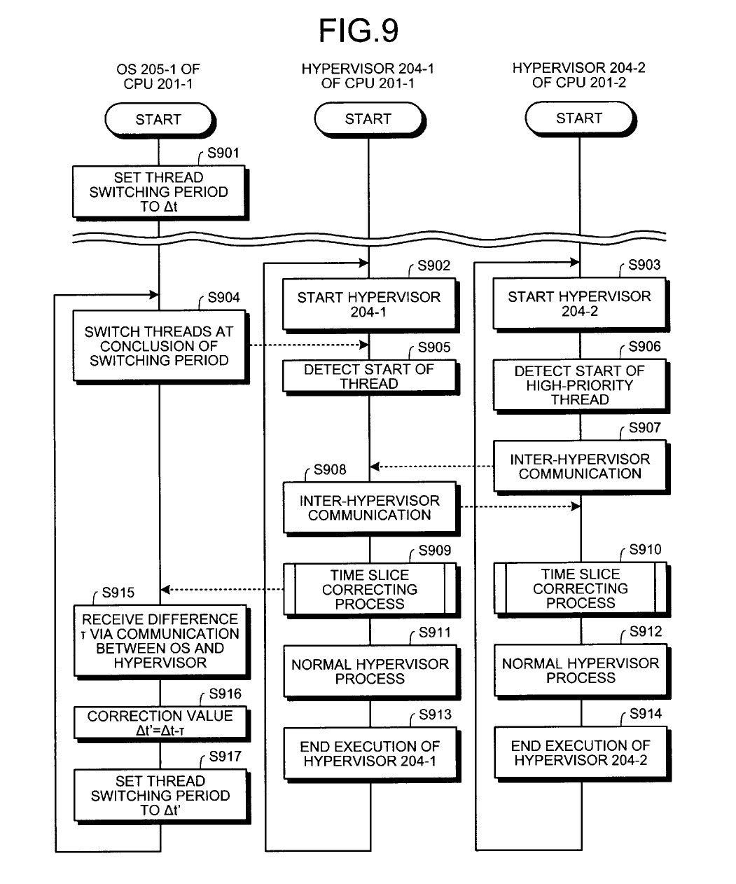

FIG. 9 is a flowchart of a time slice setting process including thread switching in the multi-core processor system 100. The CPUs 101 switch threads successively. In an initial state, the CPU 201-1 sets the thread switching period to Δt via the OS 205-1 (step S901). The CPU 201-2, which is not depicted, sets a thread switching period to Δt in the same manner.

Subsequently, the CPU 201-1 starts the hypervisor 204-1 (step S902). The hypervisor 204-1 is started at a given cycle. Likewise, the CPU 201-2 starts the hypervisor 204-2 (step S903). After the thread switching period has elapsed, the CPU 201-1 switches threads via the OS 205-1 (step S904). The CPU 201-2, which is not depicted, switches threads in the same manner.

Having switched threads, the CPU 201-1 detects the start of the thread via the function of the hypervisor 204-1 (step S905). The CPU 201-2 assumes the start of the high-priority software 209. After the high-priority software 209 is started, the CPU 201-2 detects the start of a high-priority thread via a function of the hypervisor 204-2 (step S906). Following the detection, the CPU 201-2 reports the detection of the start of the high-priority thread to all hypervisors including the hypervisor 204-1 via inter-hypervisor communication (step S907). In the same manner, the CPU 201-1 reports the detection of the start of the thread to the hypervisor 204-2 via inter-hypervisor communication (step S908).

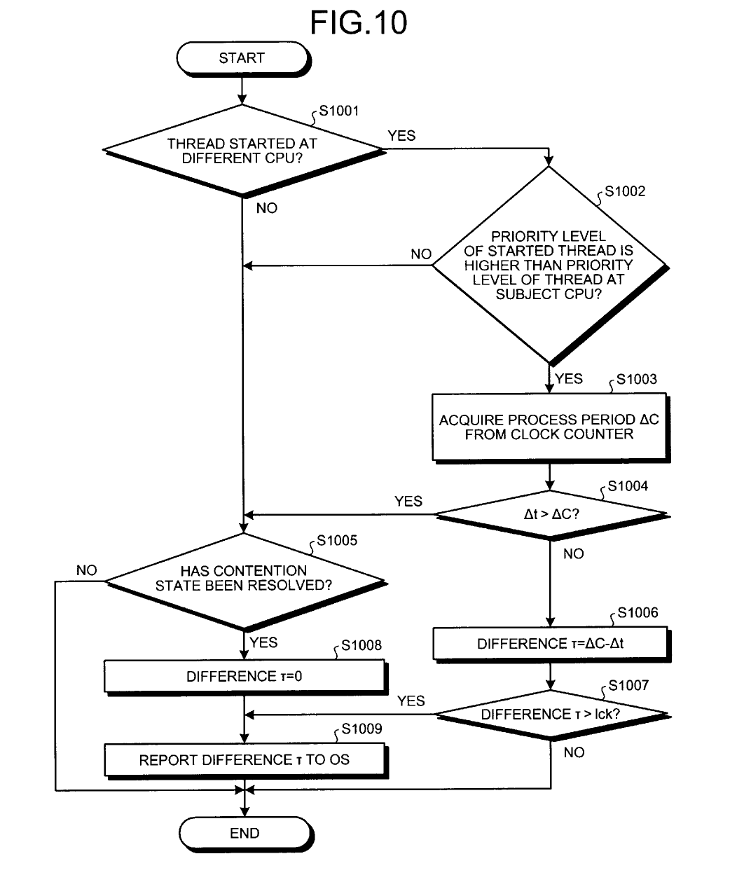

Following the report, the CPU 201-1 executes a time slice correcting process via the hypervisor 204-1 (step S909). The details of the time slice correcting process will be described later, referring to FIG. 10. Since the high-priority thread is started at a CPU other than the CPU 201-1, the CPU 201-1 has a potential of entering a state of contention. When in the contention state, the CPU 201-1 reports a difference τ to the OS 205-1 during execution of the time slice correcting process. Having finished the time slice correcting process, the CPU 201-1 causes the hypervisor 204-1 to execute a normal hypervisor process (step S911), and ends execution of the hypervisor 204-1 (step S913). Following the end of execution of the hypervisor 204-1, the CPU 201-1 proceeds to the process at step S902 after a given cycle has passed.

Likewise, the CPU 201-2 executes a time slice correcting process via the hypervisor 204-2 (step S910). Since a high-priority thread is not started at a CPU other than the CPU 201-2, the CPU 201-2 does not enter a state of contention and thus, does not make a report to the OS 205-2. Having finished the time slice correcting process, the CPU 201-2 causes the hypervisor 204-2 to execute a normal hypervisor process (step S912), and ends execution of the hypervisor 204-2 (step S914). Following the end of execution of the hypervisor 204-2, the CPU 201-2 proceeds to the process at step S903 after a given cycle has passed.

After reporting the difference τ via the hypervisor 204-1, the CPU 201-1 receives the difference τ via communication between the OS and the hypervisor (step S915). Subsequently, the CPU 201-1 calculates a correction value Δt′=Δt−τ (step S916). The calculation at step S916 is made using equation (1), but may be made using equation (2). Following the calculation, the CPU 201-1 sets the thread switching period to the correction value Δt′ via the OS 205-1 (step S917). After the thread switching period Δt′ has elapsed, the CPU 201-1 proceeds to the process at step S904.

FIG. 10 is a flowchart of the time slice correcting process by the hypervisor. The time slice correcting process is executed at any CPU among the CPUs 101. In FIG. 10, the time slice correcting process executed at the CPU 201-1 is described. The time slice correcting process is executed via the function of the hypervisor.

The CPU 201-1 determines whether a thread is started at a different CPU (step S1001). The CPU 201-1 detects the start of a thread via the inter-hypervisor communication, this detection is the process at step S908 carried out before the time slice correcting process. When determining that a thread is started at a different CPU (step S1001: YES), the CPU 201-1 then determines whether the priority level of the started thread is higher than the priority level of a thread at a subject CPU (step S1002). The subject CPU means the subject CPU that carries out the time slice correcting process, and is equivalent to the CPU 201-1 in the case of FIG. 10.

If the priority level of the started thread is higher than the priority level of the thread at the subject CPU (step S1002: YES), the CPU 201-1 acquires a process period ΔC from the clock counter (step S1003). After acquiring the process period ΔC, the CPU 201-1 determines whether a prescribed thread switching period Δt is longer than the process period ΔC (step S1004). If Δt is equal to or shorter than ΔC (step S1004: NO), the CPU 201-1 calculates the difference Δ=ΔC−Δt (step S1006). The case of (step S1004: NO) is the case where access contention arises at the CPU 201-1.

If a thread is not started at a different CPU (step S1001: NO), the CPU 201-1 determines whether a contention state has been resolved (step S1005). If the contention state have been resolved (step S1005: YES), the CPU 201-1 sets the difference τ to 0 (step S1008). Whether the contention state due to access contention has been resolved is determined in the following manner. The CPU records the number of commands issued by the CPU and values of the clock counter in a given period and then calculates (clock counter value/number of issued commands). If the calculated value is larger than a given value, the CPU determines that the contention state continues. If the calculated value is equal to or smaller than the given value, the CPU determines that the contention state has been resolved.

If the priority level of the started thread is not higher than the priority level of the thread at the subject CPU or Δt is longer than ΔC (step S1002: NO, step S1004: YES), the CPU 201-1 proceeds to the process at step S1005.

Following the process at step S1006, the CPU 201-1 determines whether the calculated difference τ is longer than the longest path period lck of the interrupt disabled interval (step S1007). If the difference τ is longer than the longest path period lck (step S1007: YES) or after ending the process at step S1007, the CPU 201-1 reports the difference τ to the OS (step S1009). After reporting the difference τ, the CPU 201-1 ends the time slice correcting process. If the difference τ is equal to or shorter than the longest path period lck (step S1007: NO) or the contention state has not been resolved (step S1005: NO), the CPU 201-1 ends the time slice correcting process.

To measure improvement in the performance of the multi-core processor system 100 of the embodiment, for example, an operation log is analyzed using a profiler or debugger, if available. If neither the profiler nor debugger is available, the performance of the system is analyzed for a case of separately executing each software and for a case of executing software simultaneously.

As described above, according to the multi-core processor system, the thread switching control method, and the thread switching control program, a CPU having switched multiple threads in a period exceeding a prescribed switching period is identified. After identifying the CPU, the multi-core processor system sets a thread switching period using a difference between an actual switching period in which a thread is actually switched and a prescribed switching period. As a result, an interval of detection of interrupt events is reduced and the frequency of detection is increased by an amount corresponding to the amount by which the interval is reduced. Hence the response performance of the real-time process is guaranteed.

Triggered by the detection of a CPU to which an arbitrary thread is assigned, the multi-core processor system may identify a CPU having switched multiple threads in a period exceeding the prescribed. Because access contention arises when threads are assigned to multiple CPUs, correction of a time slice can be executed at the best timing, triggered by assignment of a thread.

The multi-core processor system carries out the CPU identifying process triggered by detection of a CPU to which an arbitrary thread is assigned. When the priority level of the thread assigned to the detected CPU is higher than the priority level of the thread switched to at a CPU that carried out thread switching, the multi-core processor system may identify a CPU that switched multiple threads in a period exceeding the prescribed switching period.

A contention state due to access contention arises when threads are assigned to multiple CPUs in such a way that a high-priority thread is assigned to one CPU while a low-priority thread is assigned to another thread. Therefore, subject CPUs that carry out time slice correction can be narrowed down by checking whether the priority level of the thread assigned to the detected CPU is higher than the priority level of the switched thread at the CPU that carried out the thread switching.

The multi-core processor system may correct a prescribed switching period into a shorter switching period when a difference of the actual switching period and the prescribed switching period exceeds a prescribed interrupt disabled period. The multi-core processor system is designed so as to guarantee the response performance of the real-time process provided the difference of the actual switching period and the prescribed switching period does not exceed the prescribed interrupt disabled period. The multi-core processor system, therefore, corrects a time slice when the difference exceeds the prescribed interrupt disabled period. In this manner, time slice correction is carried out only when the response performance of the real-time process has the potential of failing.

The multi-core processor system may set a corrected switching period to a pre-correction switching period for a CPU that has corrected a time slice when the CPU is not in a state of access contention. In this manner, time slice correction can be cancelled by determining whether access contention is occurring, without acquiring and comparing an actual switching period with a prescribed switching period.

The thread switching control method described in the present embodiment may be implemented by executing a prepared program on a computer such as a personal computer and a workstation. The program is stored on a computer-readable recording medium such as a hard disk, a flexible disk, a CD-ROM, an MO, and a DVD, read out from the computer-readable medium, and executed by the computer. The program may be distributed through a network such as the Internet.

All examples and conditional language provided herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A multi-core processor system comprising a given core configured to:
switch at a prescribed switching period, threads assigned to the given core,
identify whether the given core has switched threads at a period exceeding the prescribed switching period,
correct the prescribed switching period into a shorter switching period, based on a difference of an actual switching period at which the threads have been switched by the given core and the prescribed switching period, and
set the corrected switching period as the prescribed switching period.

2. The multi-core processor system according to claim 1, the given core configured to detect from among the cores, a core to which an arbitrary thread is assigned, and
upon detecting the core, identify whether the given core has switched the threads at a period exceeding the prescribed switching period.

3. The multi-core processor system according to claim 2, the given core configured to identify whether the given core has switched the threads at a period exceeding the prescribed switching period, when a priority level of the arbitrary thread assigned to the detected core is higher than a priority level of a thread to which the given core has switched.

4. The multi-core processor system according to claim 3, the given core configured to correct the prescribed switching period into a shorter switching period, when at the given core identified to have switched the threads at a period exceeding the prescribed switching period, the difference of the actual switching period and the prescribed switching period exceeds a prescribed interrupt disabled period.

5. The multi-core processor system according to claim 4, the given core configured to:
determine whether memory accessed by the given core identified to have switched the threads at a period exceeding the prescribed switching period, is in a state of access contention, and
upon determining that the memory is not in a state of access contention, set the corrected switching period to a pre-correction switching period.

6. A thread switching control method executed by a given core, the method comprising:
identifying whether the given core that at a prescribed switching period, has switched threads assigned to the core and subsequently switches the threads at a period exceeding the prescribed switching period;
correcting the prescribed switching period into a shorter switching period, based on a difference of an actual switching period at which the threads have been switched at the given core identified and the prescribed switching period; and
reporting the corrected switching period.

7. A computer-readable recording medium storing a program causing a processor to execute a thread switching control process comprising:
identifying whether a core that at a prescribed switching period, has switched threads assigned to the core and subsequently switches the threads at a period exceeding the prescribed switching period;
correcting the prescribed switching period into a shorter switching period, based on a difference of an actual switching period at which the threads have been switched at the core and the prescribed switching period; and
reporting the corrected switching period.
